(19) United States
(12) Patent Application Publication
(10) Pub. No.: US 2020/0331436 A1
(43) Pub. Date: Oct. 22, 2020

(54) HEATED WASHER FLUID RESERVOIR AND WASHER FLUID HEATING SYSTEM

(71) Applicant: FORD GLOBAL TECHNOLOGIES, LLC, Dearborn, MI (US)

(72) Inventors: David Brian Glickman, Southfield, MI (US); Sean Terence Coghlan, Canton, MI (US); James Alan Acre, Monroe, MI (US); Darshan Arun Nayak, Northville, MI (US)

(21) Appl. No.: 16/387,139

(22) Filed: Apr. 17, 2019

(51) Int. Cl. B60S 1/48; B60S 1/50; F01P 5/10

(52) U.S. Cl. CPC B60S 1/488; F01P 5/10; B60S 1/50

(57) ABSTRACT

A washer fluid reservoir includes an outer wall, a washer fluid reservoir chamber defined within the outer wall and an integral heating element in the washer fluid reservoir chamber. The integral heating element includes a heat transfer efficiency heating feature. A washer fluid heating system incorporating the washer fluid reservoir is also disclosed.

### TECHNICAL FIELD

This document relates generally to the motor and autonomous vehicle fields and, more particularly, to a new and improved heated washer fluid reservoir and washer fluid heating system.

### BACKGROUND

There is a continued need for improvement in the performance of wiper and washer systems in cold weather conditions. Autonomous vehicle systems such as forward radar, moisture sensing wiper controls and camera wash systems add to the need to improve wiper and wash performance in colder weather.

The ideal solution heats the washer fluid to an ideal temperature, such as for example, a constant 21 degrees C. (i.e. a temperature not too hot so as to avoid damage to windshields and other components in cold weather) as soon as the vehicle can apply the heat, which is even before the engine is hot enough to call for cooling via the radiator cooling system or even to heat the inside cabin.

This document relates to a new and improved washer fluid reservoir and washer fluid heating system configured to provide this ideal solution.

### SUMMARY

In accordance with the purposes and benefits described herein, a new improved washer fluid reservoir is provided. That washer fluid reservoir comprises an outer wall, a washer fluid reservoir chamber defined within the outer wall and an integral heating element within the washer fluid reservoir chamber wherein the integral heating element includes a heat transfer efficiency heating feature.

The heat transfer efficiency heating feature may include at least one heat transfer fin projecting from the integral heating element toward the outer wall.

The integral heating element may include an inlet port and an outlet port. Further, the integral heating element may extend along a tortious pathway through the washer fluid reservoir chamber within the outer wall.

The integral heating element may include a conduit having an internal passageway receiving a heating fluid. In one particularly useful embodiment, the outer wall and the integral heating element are of unitary construction. Accordingly, the outer wall and the integral heating element may be 3D printed.

In accordance with an additional aspect, a washer fluid heating system is provided. That washer fluid heating system comprises a washer fluid reservoir including an outer wall, a washer fluid reservoir chamber defined within the outer wall and an integral heating element in the washer fluid reservoir chamber. Further, the washer fluid system may include a valve block adapted for (a) transmission heating and cooling and (b) washer fluid heating.

In addition, the washer fluid heating system includes a control module. That control module is connected to the valve block and adapted to (a) open a valve to direct a heating fluid through the integral heating element in response to ambient temperature falling below a predetermined temperature and (b) close the valve and prevent flow of heating fluid through the integral heating element in response to a current temperature of the washer fluid in the washer fluid reservoir chamber exceeding a second predetermined temperature.

The washer fluid heating system may further include a cooling pack having a support frame, a radiator, a condenser and the washer fluid reservoir. At least a portion of that washer fluid reservoir may extend between the radiator and the condenser on the cooling pack.

The cooling pack may further include a fan shroud and a fan assembly adapted to move air through the radiator and the condenser. Still further, the cooling pack may include an active grill shutter. In addition, in some embodiments the cooling pack may further include a charge air cooler.

The integral heating element of the washer fluid heating system may include at least one heat transfer fin projecting from the integral heating element toward the outer wall of the washer fluid reservoir. Further, the integral heating element may include an inlet port and an outlet port. Still further, the integral heating element may extend along a tortious pathway through the washer fluid reservoir chamber within the outer wall.

The integral heating element may be a conduit having an internal passageway receiving a heating fluid such as coolant from the engine. In one particularly useful embodiment, the outer wall and the integral heating element are of unitary construction. Further, the outer wall and integral heating element may be 3D printed.

In accordance with yet another aspect, a method of making a fluid reservoir is provided. That method comprises the steps of: (a) fabricating, by 3D printing, the fluid reservoir with an outer wall and an integral heating element of unitary construction and (b) orienting the integral heating element to extend through a fluid reservoir chamber defined within the outer wall.

In the following description, there are shown and described several preferred embodiments of the washer fluid reservoir, the washer fluid heating system and the related method of making a fluid reservoir. As it should be realized, the washer fluid reservoir, the washer fluid heating system and the method are capable of other, different embodiments and their several details are capable of modification in various, obvious aspects all without departing from the washer fluid reservoir, the washer fluid heating system and the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the washer fluid reservoir, washer fluid heating system and method of making a fluid reservoir and together with the description serve to explain certain principles thereof.

FIG. 1 is a schematic illustration of one possible embodiment of the washer fluid reservoir and a valve block adapted for (a) transmission heating and cooling and (b) washer fluid heating using coolant from an engine block or trans cooler of a vehicle. Note a part of the outer wall is broken away to more clearly show the washer fluid reservoir chamber, the integral heating element and the internal passageway of the integral heating element.

FIG. 2 is a schematic illustration of an alternative embodiment of the washer fluid reservoir incorporating an integral heating element that extends along a tortious pathway through the washer fluid reservoir chamber within the outer wall of the washer fluid reservoir.

FIG. 3A is a side elevational view of the new and improved washer fluid heating system incorporating the washer fluid reservoir illustrated in FIG. 1 or 2.

FIG. 3B is a perspective view of the washer fluid heating system illustrated in

FIG. 3A.

FIG. 4 is a control logic flow diagram for one possible embodiment of the washer fluid heating system illustrated in FIGS. 3A and 3B.

Reference will now be made in detail to the present preferred embodiments of the washer fluid reservoir, the washer fluid heating system and the method of making a fluid reservoir, examples of which are illustrated in the accompanying drawing figures.

### DETAILED DESCRIPTION

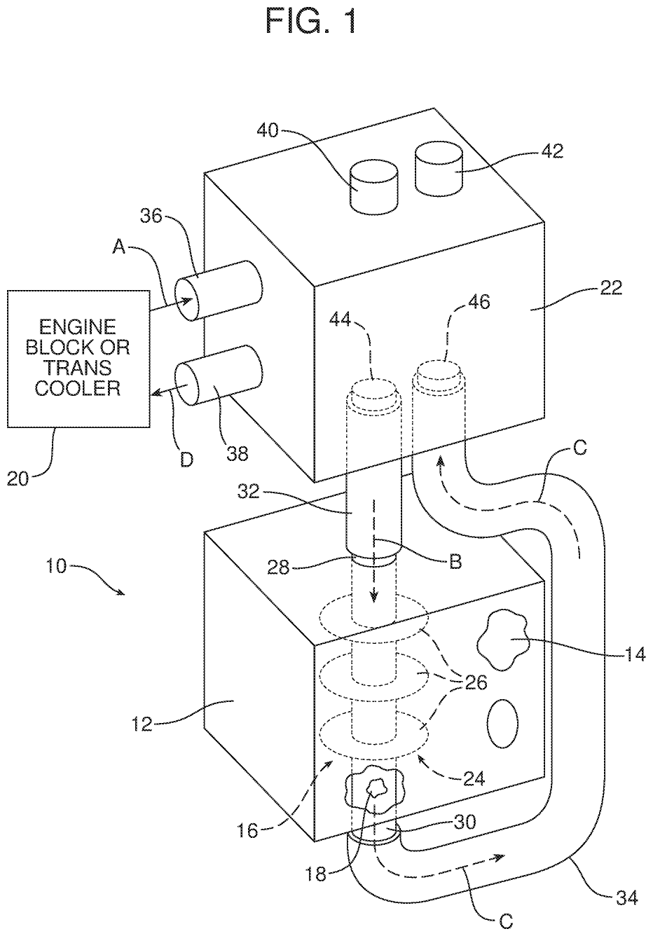

Reference is now made to FIG. 1 illustrating a first possible embodiment of a new and improved washer fluid reservoir 10. That washer fluid reservoir 10 includes an outer wall 12, a washer fluid reservoir chamber 14 defined within the outer wall and an integral heating element 16 in the washer fluid reservoir chamber. As illustrated in FIG. 1, the integral heating element 16 is a conduit having an internal passageway 18 that receives a heating fluid such as a coolant from an engine block or trans cooler 20. That coolant is directed from the engine block or trans cooler 20 by means of a valve block 22 that will be described in greater detail below.

As further illustrated in FIG. 1, the integral heating element 16 includes at least one heat transfer efficiency heating feature 24. In the illustrated embodiment, the heat transfer efficiency heating feature 24 comprises three heat transfer fins 26 projecting outward around the periphery of the integral heating element 16. Substantially any number of heat transfer fins 26 can be provided and, accordingly, it should be appreciated that the washer fluid reservoir 10 may be described as including at least one heat transfer fin.

As further illustrated in FIG. 1, the integral heating element 16 also includes an inlet port 28 and an outlet port 30. Both the inlet port 28 and the outlet port 30 in the illustrated embodiment project from the outer wall 12 and are adapted to receive the hoses 32, 34 for the transfer of coolant to and from the valve block 22.

More particularly, the valve block 22 includes a coolant inlet 36 and a coolant outlet 38 connected to the engine block or transcooler 20, a transmission outlet 40 and a transmission inlet 42 to circulate coolant to and from the transmission (not shown) in a manner known in the art and an outlet port 44 and an inlet port 46 for circulating coolant to and from the integral heating element 16 of the washer fluid reservoir 10.

Thus, it should be appreciated that: (a) action arrow A illustrates the movement of hot coolant from the engine block or transcooler 20 through coolant inlet 36 of the valve block 22, (b) action arrow B illustrates the movement of hot coolant from the valve block through to the integral heating element 16 for heat transfer to the washer fluid, (c) action arrows C illustrate the movement of the coolant from the integral heating element back to the valve block and (d) action arrow D illustrates the movement of coolant from the valve block back to the engine block or transcooler.

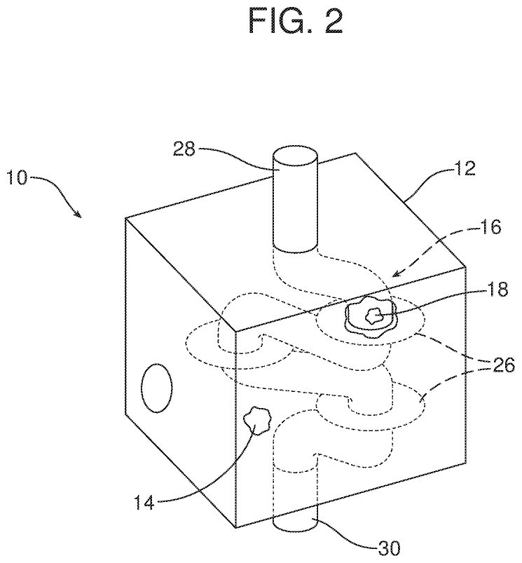

In the embodiment illustrated in FIG. 1, the integral heating element 16 extends straight through the washer fluid reservoir 14 from the inlet port 28 to the outlet port 30. In contrast, in the embodiment illustrated in FIG. 2, the integral heating element 16 extends along a tortious pathway through the washer fluid reservoir chamber 14 within the outer wall 12. Thus, the integral heating element 16 follows a long, twisting path or tortuous pathway through the reservoir chamber 14 thereby providing a greater overall surface area for heat transfer.

In one particularly useful embodiment, the entire washer fluid reservoir 10, including the outer wall 12 and the integral heating element 16 are of unitary construction. In the context of this document, “unitary construction” means made in a single piece and not assembled. Towards this end, the entire washer fluid reservoir 10 including the outer wall 12 and integral heating element 16 may be 3D printed. This may be done by means of a method comprising the steps of fabricating, by 3D printing, the fluid reservoir 14 with an outer wall 12 and an integral heating element 16 of unitary construction and orienting the integral heating element to extend through the fluid reservoir chamber 14 defined within the outer wall.

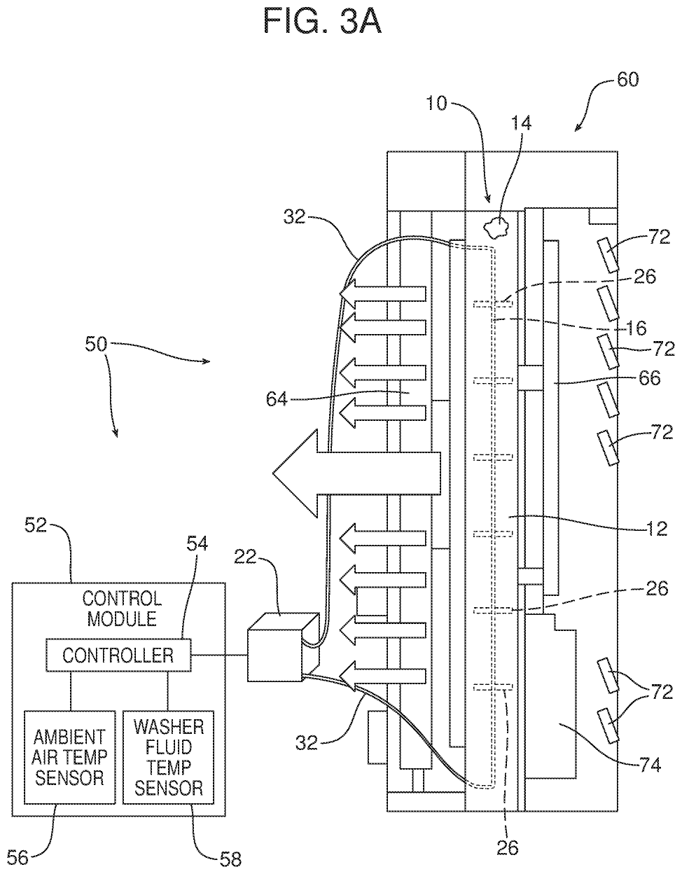

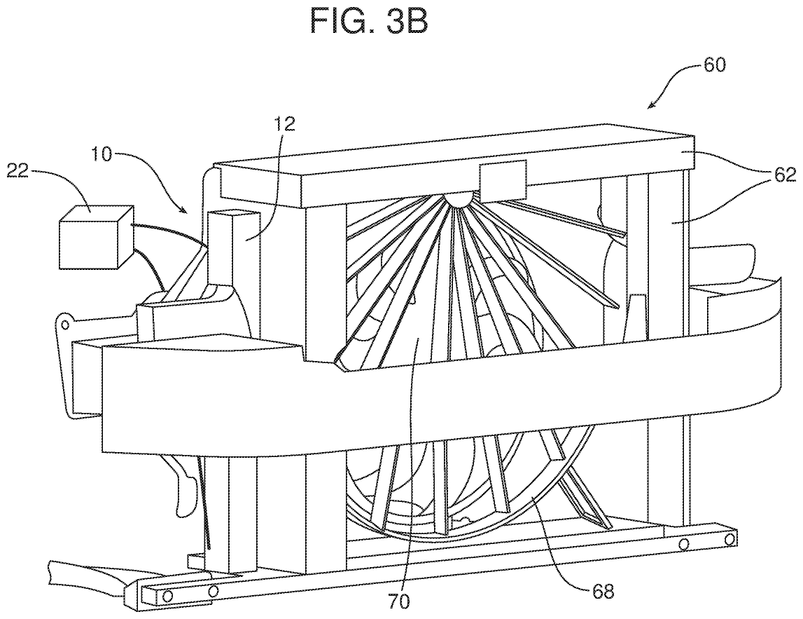

As illustrated in FIGS. 3A and 3B, a washer fluid heating system 50 is provided. That washer fluid heating system 50 comprises a washer fluid reservoir 10 of the type described above, including an outer wall 12, a washer fluid reservoir chamber 14 defined within the outer wall and an integral heating element 16 in the washer fluid reservoir chamber. In addition, the washer fluid heating system 50 includes the valve block 22 adapted for (a) transmission heating and cooling and (b) washer fluid heating. Further, the washer fluid heating system 50 includes a control module 52 connected to the valve block 22. The control module 52 includes a controller 54, an ambient air temperature sensor 56 and a washer fluid temperature sensor 58. The ambient air temperature sensor monitors 56 the current ambient air temperature while the washer fluid temperature sensor 58 monitors the current washer fluid temperature of the washer fluid contained in the washer fluid reservoir 14.

The controller 54 may comprise a computing device such as a dedicated microprocessor for an electronic control unit (ECU) operating in accordance with instructions from appropriate control software. Accordingly, the controller 54 may comprise one or more processors, one or more memories and one or more network interfaces all in communication with each other over one or more communication buses.

The controller 54 includes control logic adapted or configured to (a) open the valve block 22 to direct a heating fluid, in this case coolant, through the integral heating element 16 in response to ambient temperature falling below a first predetermined temperature and (b) close the valve in the valve block 22 and prevent flow of heating fluid through the integral heating element in response to a current temperature of washer fluid in the washer fluid reservoir chamber exceeding a second predetermined temperature.

As further illustrated in FIGS. 3A and 3B, the washer fluid heating system 50 may also include a cooling pack 60 having a support frame 62, a radiator 64, a condenser 66, a fan shroud 68 and a fan assembly 70 adapted to move air through the radiator and the condenser. Note, that the radiator 64 and the condenser 66 are removed in FIG. 3B to better show the fan shroud 68 and the fan assembly 70. The cooling pack 60 may also include an active grille shutter 72 and a charge air cooler 74. More complete details of the cooling pack are set forth in U.S. patent application Ser. No. 16/216,530 filed on Dec. 11, 2018, and entitled “Engine Cooling System,” the full disclosure of which is incorporated herein by reference.

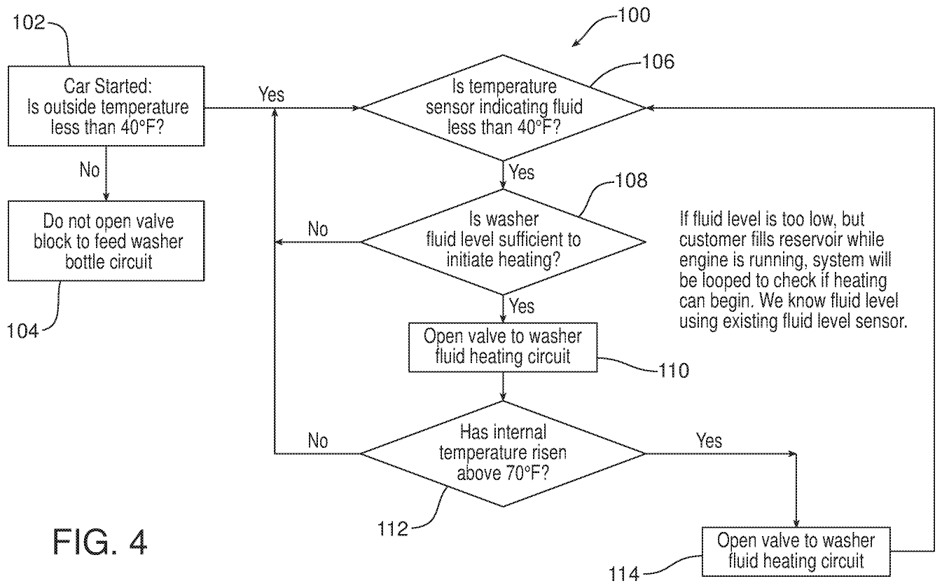

FIG. 4 illustrates a control logic flow diagram 100 for one possible embodiment of the washer fluid heating system 50. As illustrated, when the vehicle is started, the controller 54 queries whether or not the ambient outside air temperature is less than 40 degrees F./4.4 degrees C. (See Box 102.) In the event the temperature is 40 degrees F./4.4 degrees C. or above, the controller 54 does not direct the valve block 22 to open the outlet port 44 and the inlet port 46 to feed coolant to the integral heating element 16 of the washer fluid reservoir 10. (See Block 104.)

In contrast, if the outside ambient air temperature is less than 40 degrees F./4.4 degrees C. as indicated to the controller 54 by data received from the ambient air temperature sensor 56, the controller 54 next queries whether the washer fluid temperature in the washer fluid reservoir 10, as indicated by data received from the washer fluid temperature sensor 58, is less than 40 degrees F./4.4 degrees C. (See Box 106.)

If the answer is yes, the controller 54 then confirms if the washer fluid level in the washer fluid reservoir 10 is sufficient to initiate heating. (See Box 108.) This is confirmed by data received from a washer fluid level sensor (not shown).

If the answer to this last query is yes, the controller 54 then directs the valve block 22 to open the outlet port 44 and the inlet port 46 connected, respectively, to the inlet port 28 and the outlet port 30 of the washer fluid reservoir 10 by the respective hoses 32, 34. (See Block 110.) This initiates the flow of hot coolant through the internal passageway 18 of the integral heating element 16 within the outer wall 12 of the washer fluid reservoir 10. Heat transferred from the hot coolant through the walls of the integral heating element 16, including the heat transfer fins 26 of the heat transfer efficiency heating feature 24 heats the washer fluid to a desired operating temperature such as, for example, 70 degrees F./21 degrees C.

The controller 54 monitors the temperature of the washer fluid as it is being heated through the receipt of washer fluid temperature data received from the washer fluid temperature sensor 58. Once the washer fluid temperature is above 70 degrees F./21 degrees C. (See Box 112), the controller 54 closes the outlet port 44 and the inlet port 46 of the valve block 22 thereby preventing further circulation of coolant through the integral heating element 16 of the washer fluid reservoir 10. (See Box 114.)

In summary, the new and improved washer fluid reservoir 10 and the washer fluid heating system 50, incorporating that washer fluid reservoir, provide a number of benefits and advantages. The washer fluid reservoir 10 and washer fluid heating system 50 maintain optimal washer fluid temperature to minimize or avoid washer system freeze-up by using waste heat from the engine block or trans cooler 20 through operation of the valve block 22 upon direction from the controller 54. By providing a single source of heated washer fluid, in this manner, it is possible to minimize downstream heating elements and additional components for cameras and other autonomous vehicle systems that need free washer fluid operation.

By utilizing a washer fluid reservoir 10 incorporating an outer wall 12 and an integral heating element 16 of unitary construction, the durability of the washer fluid reservoir 10 is increased while leaks are eliminated. Further, the heat transfer heating efficiency of the integral heating element 16 is enhanced in a significant manner by the provision of the heat transfer fins 26 and/or the utilization of a tortious pathway such as illustrated in FIG. 2.

The foregoing has been presented for purposes of illustration and description. It is not intended to be exhaustive or to limit the embodiments to the precise form disclosed. Obvious modifications and variations are possible in light of the above teachings. For example, the control values indicated in FIG. 4 and discussed above are to be considered exemplary and not restrictive in any manner. Further, the control set point may be based on another value such as windshield surface temperature instead of ambient temperature. Similarly, the integral heating element 16 and heat transfer efficiency heating feature 24 illustrated in FIGS. 1 and 2 are merely examples of possible shapes and it should be appreciated that other shapes could be provided. All such modifications and variations are within the scope of the appended claims when interpreted in accordance with the breadth to which they are fairly, legally and equitably entitled.

1. A washer fluid reservoir, comprising:
an outer wall;
a washer fluid reservoir chamber defined within said outer wall; and
an integral heating element in said washer fluid reservoir chamber wherein said integral heating element includes a heat transfer efficiency heating feature.

2. The washer fluid reservoir of claim 1 wherein said heat transfer efficiency heating feature includes at least one heat transfer fin projecting from said integral heating element toward said outer wall.

3. The washer fluid reservoir of claim 2, wherein said integral heating element includes an inlet port and an outlet port.

4. The washer fluid reservoir of claim 3, wherein said integral heating element extends along a tortuous pathway through said washer fluid reservoir chamber within said outer wall.

5. The washer fluid reservoir of claim 3, wherein said integral heating element is a conduit having an internal passageway receiving a heating fluid.

6. The washer fluid reservoir of claim 3, wherein said outer wall and said integral heating element are of unitary construction.

7. The washer fluid reservoir of claim 3, wherein said outer wall and said integral heating element are 3D printed.

8. A washer fluid heating system, comprising:
a washer fluid reservoir including an outer wall, a washer fluid reservoir chamber defined within said outer wall and an integral heating element in said washer fluid reservoir chamber;
a valve block adapted for transmission heating and cooling and washer fluid heating; and
a control module connected to said valve block and adapted to open a valve to direct a heating fluid through said integral heating element in response to ambient temperature falling below a first predetermined temperature and close said valve and prevent flow of heating fluid through said integral heating element in response to a temperature of washer fluid in said washer fluid reservoir chamber exceeding a second predetermined temperature.

9. The washer fluid heating system of claim 8, further including a cooling pack including a support frame, a radiator, a condenser and said washer fluid reservoir.

10. The washer fluid heating system of claim 9, wherein at least a portion of said washer fluid reservoir extends between said radiator and said condenser.

11. The washer fluid heating system of claim 10, wherein said cooling pack further includes a fan shroud and a fan assembly adapted to moving air through said radiator and said condenser.

12. The washer fluid heating system of claim 11, wherein said cooling pack further includes an active grille shutter.

13. The washer fluid heating system of claim 12, wherein said cooling pack further includes a charge air cooler.

14. The washer fluid heating system of claim 13, wherein said integral heating element includes at least one heat transfer fin projecting from said integral heating element toward said outer wall.

15. The washer fluid heating system of claim 14, wherein said integral heating element includes an inlet port and an outlet port.

16. The washer fluid heating system of claim 15, wherein said integral heating element extends along a tortuous pathway through said washer fluid reservoir chamber within said outer wall.

17. The washer fluid heating system of claim 15, wherein said integral heating element is a conduit having an internal passageway receiving said heating fluid.

18. The washer fluid heating system of claim 15, wherein said outer wall and said integral heating element are of unitary construction.

19. The washer fluid heating system of claim 15, wherein said outer wall and said integral heating element are 3D printed.

20. A method of making a fluid reservoir, comprising:
fabricating, by 3D printing, the fluid reservoir with an outer wall and an integral heating element of unitary construction; and
orienting said integral heating element to extend through a fluid reservoir chamber defined within said outer wall.
